(19) United States
(12) Patent Application Publication
(10) Pub. No.: US 2024/0157400 A1
(43) Pub. Date: May 16, 2024

(54) A CLASSIFIER AND A PULVERIZER COMPRISING THE CLASSIFIER AND A METHOD OF OPERATING THE PULVERIZER AND A USE OF THE CLASSIFIER

(71) Applicant: General Electric Technology GmbH, Baden (CH)

(72) Inventors: Krishnendu ADITYA, Noida, Uttar Pradesh (IN); Satya Sai Ramchandra Rao INDRAGANTI, Noida, Uttar Pradesh (IN); Kousik DAS, Noida, Uttar Pradesh (IN); Samaresh SAHOO, Kolkata, West Bengal (IN)

(21) Appl. No.: 18/552,603

(22) PCT Filed: Mar. 1, 2022
(86) PCT No.: PCT/EP2022/025072

§ 371 Date: Sep. 26, 2023

(30) Foreign Application Priority Data
Apr. 1, 2021 (IN) 202111015682

(51) Int. Cl. B07B 7/086; B02C 15/04; B02C 23/10

(52) U.S. Cl. CPC B07B 7/086; B02C 15/04; B02C 23/10

(57) ABSTRACT

A classifier comprising deflector ring having an interior sidewall liner affixed to an interior sidewall of deflector ring and an exterior sidewall liner affixed to an exterior sidewall of deflector ring, outlet housing, a base region formed on a top surface of deflector ring, outlet housing sidewalls, each extending away from an edge of deflector ring, and a top region parallel to base region joined with each angled sidewalls, top region having an upper surface with one or more openings formed therein corresponding to one or more outlet channels, wherein outlet housing further comprises an interior sidewall liner affixed to each of opposing angled sidewalls, each interior sidewall liner extending from a corresponding edge of deflector ring to a respective portion of top region, and an upper wall liner extending along all of inner wall between one or more openings.

### BACKGROUND

### Technical Field

Embodiments of the invention relate generally to a classifier that separates fine particles from coarse particles, a pulverizer system that pulverizes raw materials to a fine feed material, a pulverizer system that comprises the classifier, and a method of operating the pulverizer and a use of the classifier, such that the classifier allows the separated fine particles to flow out of the pulverizer, while restricting the coarse particles from leaving the pulverizer .

### Discussion of Prior Art

Pulverizer systems such as vertical pulverizer systems are commonly used to process raw material for application with a variety of power generation systems. For example, a vertical pulverizer can grind coal into a desired fineness for use as a fuel in a boiler to produce steam that is utilized by a steam turbine to spin a generator which generates power. A challenge for many coal-based power generation systems is that these power generation systems were designed to use a low ash coal, which is different than the type of coal that is presently available in many locations. In addition to having more ash, this coal is often characterized as having a degradation in the Hardgrove Grindability Index (HGI). Coal with a degraded HGI corresponds to coal with a harder texture that is less grindable. High moisture is another issue associated with presently available coal. In particular, high moisture in coal can affect the grindability of the coal. The result of more ash in the coal along with the coal having a degraded HGI and a high moisture content, is that this necessitates that the pulverizers run additional milling operations to grind the coal to a desired size for use as fuel in these coal-based power generation systems. The additional milling requires an increase in auxiliary power to effectuate such operations. In some cases, the additional milling may require the use of standby pulverizers, which in addition to reducing the amount of standby pulverizers that are available for other operations, also adds to an increase in auxiliary power and costs due to maintenance of using these standby pulverizers.

In accordance with the teachings of the prior art, it has been known to employ classifiers with pulverizers for separating particles that allow fine particles to flow out of the pulverizers, while restricting coarse particles from leaving the pulverizers. In this regard, by way of exemplification and not limitation, reference may be had in this regard to U.S. Pat. No. 10,668,476, for a teaching of a vertical pulverizer that uses a static classifier for separating particles. As taught in U.S. Pat. No. 10,668,476, a static classifier may be positioned within an enclosure and coupled to a cover. In this configuration, processed particles of raw material within the vertical pulverizer system must pass through the static classifier before passing into the cover for eventual discharge from the pulverizer. To this extent, the static classifier of U.S. Pat. No. 10,668,476 receives processed particles of raw material and screens and/or filters the particles to determine if the particles meet a characteristic size to pass through the classifier.

In another example of a classifier used with a pulverizer, reference may be had in regard to U.S. Pat. No. 7,448,565, for a teaching of a primary classifier at a location in the pulverizer where the raw material is processed (i.e., pulverized). As taught in U.S. Pat. No. 7,448,565, a primary classifier may be positioned about the rotatable table, the grinding platform, and the vane wheel assembly of the pulverizer. In this configuration, the raw material that is deposited onto the grinding platform of the rotatable table is pulverized while flash-dried with a high temperature gas via the vane wheel assembly. The primary classifier separates particles of the pulverized material into undesired particles that are too big, too hard, impure, etc., and particles that are of a desired size. To this extent, the primary classifier of U.S. Pat. No. 7,448,565 rejects, discharges, discards and/or removes the undesired particles, and directs the desired particles in an upward direction of the pulverizer for further processing.

Although the classifiers associated with U.S. Pat. Nos. 10,668,476 and 7,448,565 have proven to be effective in accomplishing classification of the pulverized materials, there is room for improvement. Specifically, the known solutions require improvement in terms of coal fineness while maintaining ease of operation. There is also a need for improvement of retention time of fuel introduced into a pulverizer. Additionally, known pulverizers tend to require frequent services and thus there is a need for improvement of wear rate of parts that form pulverizers.

### BRIEF DESCRIPTION OF THE INVENTION

The invention provides a classifier and a pulverizer comprising said classifier and a method of operating said pulverizer that solves problems known in the prior art. Specifically, the classifier and the pulverizer according to the invention have improved wear life. Also, the method according to the invention ensures that the pulverizer can work for a longer period of time without the need of servicing. Furthermore, it has been observed that the invention provides an improved fineness control and more stable operation. The invention also provides an improved coal flow rate and thus improved efficiency.

In one aspect, the invention pertains to a classifier comprising an annular body having a plurality of spaced static vanes extending inwardly from an interior sidewall of the annular body, the plurality of spaced static vanes separating the annular body into a plurality of sections, wherein the plurality of spaced static vanes are configured to divide a swirling flow of particles entering the annular body into a plurality of swirling flows of particles circulating about the plurality of sections of the annular body, a deflector ring located interior to the annular body, circumferentially facing the inwardly extending plurality of spaced static vanes, wherein the deflector ring is configured to receive the plurality of swirling flows of particles circulating about the annular body, an outlet housing having one or more outlet channels mounted over the deflector ring, wherein the outlet housing is in fluid communication with the deflector ring, wherein the outlet housing is configured to receive fine particles in the plurality of swirling flows of particles that are directed upward from the deflector ring and guide the fine particles in the plurality of swirling flows into a plurality of controlled flows that are communicated to the one or more outlet channels for discharge, and a reject cone extending downward from a bottom side of the annular body, wherein the reject cone having an upper region co-planar with the bottom side of the annular body and reject cone opposing sidewalls, each extending inward at an angle away from an edge of the bottom side of the annular body, and a lower region parallel to the upper region, wherein the reject cone is configured to receive coarse particles falling out from the plurality of swirling flows of particles in the upper region and direct the falling coarse particles in a direction away from annular body, the deflector ring and the outlet housing towards the lower region of the reject cone for removal therefrom, wherein the deflector ring comprises an interior sidewall liner circumferentially affixed to an interior sidewall of the deflector ring and an exterior sidewall liner circumferentially affixed to an exterior sidewall of the deflector ring, the outlet housing comprises a frusto-conical shaped body, a base region formed on a top surface of the deflector ring, outlet housing opposing sidewalls, each extending outward at an angle away from an edge of the top surface of the deflector ring, and a top region parallel to the base region that joins with each of the opposing angled sidewalls extending outward from the edge of the top surface of the deflector ring, the top region having an upper surface extending thereover with one or more openings formed therein corresponding to the one or more outlet channels, wherein the outlet housing further comprises an interior sidewall liner affixed to an interior of each of the opposing angled sidewalls, each interior sidewall liner extending from a corresponding edge of the top surface of the deflector ring to a respective portion of the top region, and an upper wall liner affixed to an inner wall of the upper surface of the top region, the upper wall liner extending along all of the inner wall of the upper surface of the top region formed between the one or more openings.

The classifier according to an invention can be provided in various embodiments. Said embodiments are compatible with each other and thus they can be combined in any order and/or number thereby forming new embodiments.

In one embodiment, the reject cone comprises an interior sidewall liner affixed to each interior surface of the sidewalls of the reject cone and an exterior sidewall liner affixed to each exterior surface of the sidewalls of the reject cone.

In one embodiment, the interior sidewall liners and the exterior sidewall liners extend from the upper region to the lower region of the reject cone.

In one embodiment, the upper wall liner affixed to the inner wall of the upper surface of the top region of the outlet housing comprises an outlet channel extension liner that extends upward along inner walls of the one or more outlet channels.

In one embodiment, the interior sidewall liner, the exterior sidewall liner, upper wall liner and/or outlet channel extension liner comprises a ceramic liner material, wear resistant plates and/or Hi-Chrome alloy castings.

In one embodiment, a spout is coupled to the lower region of the reject cone.

In another aspect, the invention pertains to a pulverizer comprising a substantially closed separator body configured to receive particles of material, a rotatable table located in the interior of the substantially closed separator body configured to receive the particles of material, at least one grinding roll configured to grind the particles of material against the rotatable table, a gas inlet to the substantially closed separator body, wherein the gas inlet is configured to direct an upward flow of gas from circumferential regions of the rotatable table, wherein the upward flow of gas directs pulverized particles of material received at the circumferential regions of the rotatable table due to centrifugal forces of the rotatable table in an upward direction, wherein the pulverized particles are entrained in the upward flow of gas, a classifier supported in the substantially closed separator body above the rotatable table to receive the upward flow of pulverized particles from the rotatable table, wherein the classifier is configured to sort the particles entrained in the upward flow into particles of a desired size and particles of an undesired size, wherein the classifier directs the particles of the desired size out from a top surface of the substantially closed separator body and directs the particles of the undesired size back towards the rotatable table for additional grinding with the at least one grinding roll, wherein the classifier is in accordance with the invention described herein.

The pulverizer according to an invention can be provided in various embodiments. Said embodiments are compatible with each other and thus they can be combined in any order and/or number thereby forming new embodiments.

In one embodiment, an abrasion resistant liner is affixed to an interior surface of the top surface of the substantially closed separator body and a portion of sidewalls extending downward from the top surface of the substantially closed separator body.

In one embodiment, the abrasion resistant liner affixed to the interior surface of the top surface of the substantially closed separator body joins with the exterior sidewall liner circumferentially affixed to the exterior sidewall of the deflector ring.

In one embodiment, the abrasion resistant liner affixed to the interior surface of the top surface of the substantially closed separator body extends along the entire inner wall of the top surface from an edge of the top surface of the deflector ring covering over a portion of an upper region of the annular body, extending outward beyond a periphery of the annular body and the reject cone, and downward beyond the annular body, facing an upper portion of the inward angled sidewalls of the reject cone.

In one embodiment, an inlet channel extends through the substantially closed separator body into the classifier to supply the particles of material to the rotatable table, wherein the inlet channel comprises an inverted cone at a lower portion of the inlet channel.

In one embodiment, the abrasion resistant liner comprises a ceramic liner material, wear resistant plates and/or Hi-Chrome alloy castings.

In another aspect, the invention is a method of operation of a pulverizer according to the invention, wherein said method comprises providing feed of coal to the pulverizer and obtaining pulverized coal from the pulverizer.

In yet another aspect, the invention pertains to a use of the classifier according to the invention for separating particles of coal in a pulverizer.

Providing liner on the deflector ring and on the outlet housing according to the invention is essential for ensuring a longer wear life of the classifier. The pulverizer according to the invention with the abrasion resistant liner has a further improved wear life. The improved wear life is especially associated with a liner comprising a ceramic liner material. Specifically, ceramic lining on all the exposed surfaces of Carbon Steel material in classification zone gives a longer life of these components, which provides considerably improved availability and reliability of the classification.

The use of a frusto-conical shaped body ensures a proper coal-air flow distribution and thus improve coal flow and, hence, efficiency. The spout at the lower region of the reject cone is beneficial for obtaining a better fineness. The inverted cone at the lower portion of the material inlet channel is beneficial as it allows for a pulverizer to run with higher coal throughput with desired fineness.

Modifying these components in the aforementioned manner not only results in better management of the coal and air in the pulverizers because these changes allow one to dynamically manage the coal and air, but also obviates the need to make major structural changes to existing components (e.g., motor, fan, duct, feeder, etc.) or introduce new hardware, all of which can be costly. The better management of the coal and air that is attained results in improved efficiency in the crushing, milling and pulverizing operations, and consequently, allows the pulverizers to run with higher coal throughput with desired fineness.

### DRAWINGS

The present invention will be better understood from reading the following description of non-limiting embodiments, with reference to the attached drawings, wherein below:

FIG. 1 depicts a cross-section view of a pulverizer according to an embodiment of the present invention;

FIG. 2 depicts a more detailed view of the classifier and substantially closed separator body of the pulverizer depicted in FIG. 1 according to an embodiment of the present invention;

FIG. 3 depicts a schematic representation of the distribution and movement of particles of milled material in the pulverizer depicted in FIG. 1 that can be attained according to an embodiment of the present invention; and

FIG. 4 depicts a mill throughput (coal flow rate) comparison at similar motor current and fineness for a pulverizer according to the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

While embodiments of the invention are directed to restoring the milling capacity of a pulverizer used to crush, mill and pulverize coal (including Anthracite, Bituminous, Subbituminous, Lignite) to a desired size for use as fuel in a coal-based power generation system, these embodiments are suitable for any pulverizer that is used to crush, mill and pulverize a raw material. An illustrative, but non-limiting example, of other raw material that is suitable for use with the pulverizer of the various embodiments described herein includes concrete, limestone, cement, slag, pet coke, etc.

### Example 1

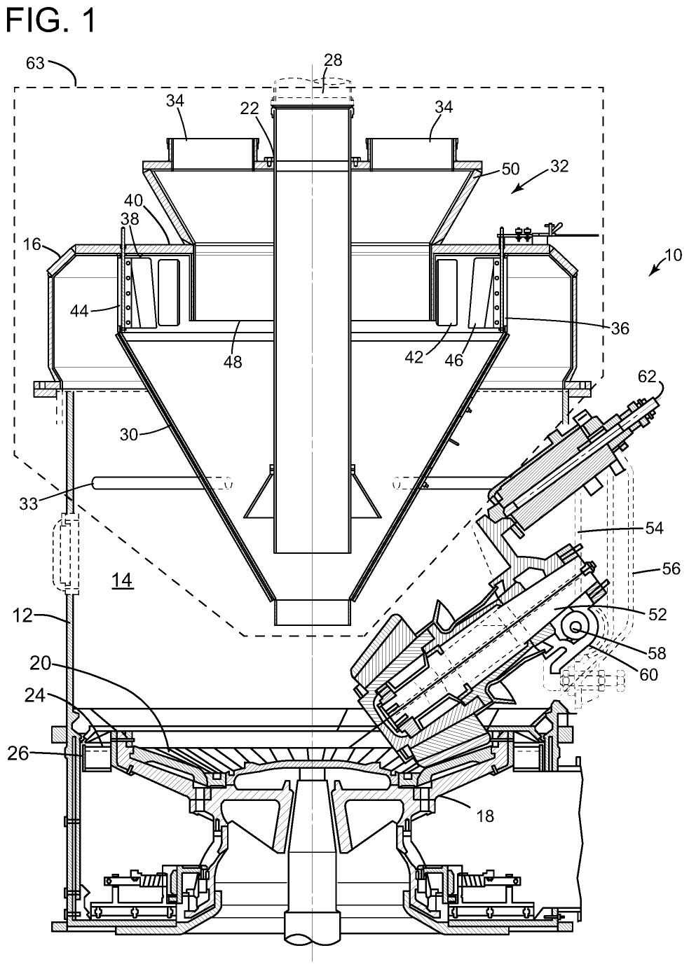

Referring now to FIG. 1, a pulverizer 10 for milling solid particles of raw material such as coal for use as fuel in a coal-fired boiler of a coal-based power generation system is shown in accordance with an embodiment of the present invention. The pulverizer 10 includes a substantially-closed separator body 12, which also can be referred to as a mill body or housing. In general, the separator body 12 can include a cylindrical body having an internal cavity 14, and a separator top cover 16. A rotatable table 18 can be positioned within the internal cavity 14 of the separator body 12. The rotatable table 18 can be coupled to a drive system gear box and motor with coupling. In this manner, the rotatable table 18 may be configured to rotate with the gearbox. To this extent, during operation of the pulverizer 10, the gearbox may rotate and/or turn the rotatable table 18.

The rotatable table 18 can include a grinding platform 20 positioned within the internal cavity 14 of the separator body 12. As shown in FIG. 1, the grinding platform 20 can be positioned below the separator top cover 16. In one embodiment, the grinding platform 20 can be aligned with a material inlet channel 22 formed in the separator top cover 16 that can be used to supply the raw material such as coal into the separator body 12 of the pulverizer 10 for grinding, milling and pulverization of the coal. The grinding platform 20 of the rotatable table 18 may extend nearly the entire width of the cylindrical body of the separator body 12. A space may be formed between an end of the grinding platform 20 of the rotatable table 18 and the inner surface of the cylindrical body of the separator body 12 so that additional components may be positioned therebetween.

For example, a vane wheel assembly 24 may be positioned between the grinding platform 20 of the rotatable table 18 and the cylindrical body of the separator body 12. As shown in FIG. 1, the vane wheel assembly 24 may substantially surround the grinding platform 20, and may provide a space, separation and/or opening between the grinding platform 20 and the cylindrical body of the separator body 12. In a non-limiting example, the vane wheel assembly 24 may be coupled to the grinding platform 20 and may rotate with the grinding platform 20 and/or the rotatable table 18. In another non-limiting example, the vane wheel assembly 24 may be fixed to the inner surface of the cylindrical body of the separator body 12 and remain static as the grinding platform 20 and/or rotatable table 18 rotate within the separator body 12.

In operation of the pulverizer 10, the vane wheel assembly 24 may provide a passage for hot gas (e.g., air) supplied to the separator body 12 through a gas inlet 26 provided in the separator body 12. The hot gas can flow up to the grinding platform 20 via the passage from the vane wheel assembly 24 and flash-dry the raw material on the grinding platform. In addition, this passage can be used to receive raw material falling from the grinding platform 20 that has been rejected, discharged and/or discarded from the grinding platform. This rejected, discharged and/or discarded raw material can collect in an area designed to receive the undesired material.

A material feed pipe 28 can supply raw material such as coal into the separator body 12 of the pulverizer 10 through the material inlet channel 22 formed in the separator top cover 16. For example, the material feed pipe 28 can be coupled to, positioned within and/or positioned through the material inlet channel 22 of the separator top cover 16. The material feed pipe 28 may also extend into the internal cavity 14 of the cylindrical body of the separator body 12, and may be positioned above the grinding platform 20 of the rotatable table 18. In one embodiment, the material feed pipe 28 can extend completely through and/or beyond the separator top cover 16 into the cylindrical body of the separator body 12. For example, as shown in FIG. 1, the material feed pipe 28 can extend through the separator top cover 16 and at least partially through a reject cone 30 which is part of a classifier 32 of the pulverizer 10. The classifier 32 is configured to perform a number of functions that can include screening the milled material for particles of a desired size from particles having an undesired size, and distributing these particles for use as fuel in the case of the particles having the desired size, and for processing or removal for the particles having the undesired size.

The classifier 32 may be positioned within the internal cavity 14 of the separator body 12. In one embodiment, the classifier 32 can be supported within the internal cavity 14 of the separator body 12 by a fastening means 33 that can include, but are not limited to pipes/tubes, flanges, bolt-nuts, etc. In this manner, the classifier 32 can be coupled to the separator top cover 16 and/or the cylindrical body of the separator body 12, and extend above the grinding platform 20 of the rotatable table 18. In this configuration, the separator top cover 16 may substantially surround and/or seal the classifier 32 to prevent processed particles of the raw material within the pulverizer 10 from passing into the separator top cover 16 without first passing through the classifier 32. To this extent, the classifier 32 can receive particles of raw material processed at the grinding platform 20 of the rotatable table 18 for screening and/or filtering of the particles. In this manner, the classifier 32 can determine if the particles meet a characteristic threshold(s) (e.g., a desired size) to pass through the classifier 32 and ultimately out of the separator body 12 via one or more particle outlet channels 34 disposed in the separator top cover 16. The classifier 32 can be any suitable particle screening device that may screen the particles processed in a vertical pulverizer mill such as the pulverizer 10 depicted in FIG. 1. Examples of classifiers that are suitable for use with the pulverizer 10 include, but are not limited to, static classifiers and dynamic classifiers.

In one embodiment, the classifier 32 can include a static classifier having an annular body 36, also positioned about the separator top cover 16, the reject cone 30, the material inlet channel 22, and the material feed pipe 28. As shown in FIG. 1, the annular body 36 can be located over the reject cone 30, adjacent to an interior surface 38 of a top surface 40 of the separator top cover 16. To this extent, the annular body 36 can form a drum section within the classifier 32. The annular body 36 may have a plurality of spaced static vanes 42 extending inwardly from an interior sidewall 44 of the annular body 36. The plurality of spaced static vanes 42 can separate the annular body 36 into a plurality of sections 46. In this manner, the plurality of spaced static vanes 42 are configured to divide a swirling flow of particles entering the annular body 36 into a plurality of swirling flows of particles circulating about the plurality of sections 46 of the annular body 36. The classifier 32 can further include a deflector ring 48 located interior to the annular body (e.g., mounted within or concentrically arranged within the annular body). In this manner, the deflector ring 48 is configured to receive the plurality of swirling flows of particles circulating about the annular body 36. The classifier 32 can also include an outlet housing 50 mounted over the deflector ring 48 that extends through the top surface 40 of the separator top cover 16, such that the one or more particle outlet channels 34 extend out through the outlet housing 50. In this manner, the outlet housing 50 can be in fluid communication with the deflector ring 48. As a result, the outlet housing 50 can receive the particles of the desired size in the plurality of swirling flows of particles that are directed upward from the deflector ring 50, and guide these particles into a plurality of controlled flows that are communicated to the one or more outlet channels 34 for discharge from the separator body 12. Further details of the classifier 32 including the reject cone 30, the annular body 36, the deflector ring 48 and the outlet housing 50 are discussed below.

Turning the discussion back to the other elements that can comprise the pulverizer 10. For example, FIG. 1 shows the pulverizer 10 having a grinding roll such as a journal 52 positioned within the separator body 12. In one embodiment, the journal 52 may be positioned within the internal cavity 14, adjacent the journal openings 54 and/or the journal opening covers 56. Additionally, the journal 52 may be positioned above the rotatable table 18, and below the separator top cover 16 and the classifier 32. Specifically, the journal 52 may be positioned directly adjacent the grinding platform 20 of the rotatable table 18. In one embodiment, the journal 52 may be positioned directly adjacent the grinding platform 20 such that a minimal space or distance may exist between the grinding platform 20 and the journal 52 to allow raw material to pass under and/or be ground by the journal 52. In a non-limiting example, the journal 52 may be configured to rotate and may contact, grind and/or crush raw material on the grinding platform 20 of the rotatable table 18 into a desired particle size.

Although only one journal 52 is shown in FIG. 1, it is understood that the pulverizer 10 may include more journals 52. That is, it is understood that the number of depicted journals 52 included in the pulverizer 10 of FIG. 1 is merely illustrative and not meant to be considered limiting. Additionally, the number of journals 52 in the pulverizer 10 depicted in FIG. 1 may or may not directly correlate to the number of journal openings 54 and/or journal opening covers 56 included within the separator body 12. For example, the separator body 12 may include three (3) journal openings 54 and/or journal opening covers 56. As a result, the pulverizer 12 may include three (3) journals 52 to match the number of journal openings 54 and/or journal opening covers 56. Alternatively, the pulverizer 12 may include one (1) or two (2) journals 52 positioned adjacent and/or within only a portion of the journal openings 54 and/or the journal opening covers 56 in the separator body 12.

As shown in FIG. 1, the journal 52 may be suspended and/or supported within the separator body 12 via a trunnion 58 positioned adjacent the journal opening cover 56. The trunnion 58 may be coupled to the journal 52, and may be configured to adjust the angle of the journal 52 within the separator body 12, which may in turn adjust the distance between the grinding platform 20 of the rotatable table 18 and the journal 52. In a non-limiting example shown in FIG. 1, the trunnion 58 may also be positioned on, coupled to and/or supported by a trunnion support 60 of the journal opening cover 56. Additionally, in the non-limiting example, at least a portion of the trunnion 58 may be positioned within the internal cavity 14 of the separator body 12. That is, as shown in FIG. 1, a center of the trunnion 58 may be in substantial alignment with the journal opening 56, or alternatively the center of the trunnion 58 may be positioned within the internal cavity 14 of the separator body 12. As such, a portion of the trunnion 58 may extend into the journal opening cover 56 and a distinct portion of the trunnion 58 may extend into the internal cavity 14 of the separator body 12. By positioning a portion, a majority and/or the center of the trunnion 58 within the internal cavity 14, the journal 52 coupled to the trunnion 58 may be smaller in size, more easily adjusted (e.g., angularly) toward the grinding platform 20, and/or the journal 52 and the trunnion 58 may require less space (e.g., width, height) within the separator body 12. Additionally, the positioning and/or orientation of the trunnion 58 may allow for a smaller or lower clearance for the journal 52 through the journal opening 54 when the journal 52 is removed from the separator body 12 for maintenance and/or inspection. As a result, the journal opening 54, the journal opening cover 56 and ultimately the separator body 12 may be smaller in size (e.g., height, width, circumference), and require less material and/or time for manufacturing and assembly.

Additionally, as shown in FIG. 1, the pulverizer 10 may also include a journal spring assembly 62. The journal spring assembly 62 may be coupled to a door of the journal opening cover 56 of the separator body 12. More specifically, the journal spring assembly 62 may be coupled to and/or positioned partially through an opening formed in the door of the journal opening cover 56. As a result, a portion of the journal spring assembly 62 positioned through the door may be positioned within the journal opening cover 56. In one embodiment, the journal spring assembly 62 may be coupled to the journal 52 and/or the trunnion 58. To this extent, the journal spring assembly 62 may be configured to apply a load to the journal 52 of the pulverizer 10 to ensure raw material is processed within the pulverizer. In addition, the journal spring assembly 62 may be configured to provide “give,” shock absorption and/or allow for temporary displacement of the journal 52 during the raw material grinding or milling process.

It is understood that the pulverizer 10 may have other components in addition to, or in place of those described above with respect to FIG. 1. For example, the pulverizer 10 may include the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. In one embodiment, the pulverizer 10 may include at least one processor and system memory/data storage structures in the form of a controller. The memory may include random access memory (“RAM”) and read-only memory (“ROM”). The at least one processor may include one or more conventional microprocessors and one or more supplementary co-processors such as math co-processors or the like. The data storage structures may include an appropriate combination of magnetic, optical and/or semiconductor memory, and may include, for example, RAM, ROM, flash drive, an optical disc such as a compact disc and/or a hard disk or drive.

In one embodiment, a software application that provides for control over one or more of the various components of the pulverizer 10 may be read into a main memory of the at least one processor from a computer-readable medium. The term “computer-readable medium”, as used herein, refers to any medium that provides or participates in providing instructions to the at least one processor (or any other processor of a device described herein) for execution. Such a medium may take many forms, including but not limited to, non-volatile media and volatile media. Non-volatile media may include, for example, optical, magnetic, or opto-magnetic disks, such as memory. Volatile media may include dynamic random access memory (“DRAM”), which typically constitutes the main memory. Common forms of computer-readable media may include, for example, a floppy disk, a flexible disk, hard disk, magnetic tape, any other magnetic medium, a CD-ROM, DVD, any other optical medium, a RAM, a PROM, an EPROM or EEPROM (electronically erasable programmable read-only memory), a FLASH-EEPROM, any other memory chip or cartridge, or any other medium from which a computer can read.

The pulverizer 10 of FIG. 1 can operate and perform processes in the following manner. For example, raw material such as coal may be initially provided to the separator body 12 via the material feed pipe 28. The material feed pipe 28 can deposit the coal onto the grinding platform 20 of the rotatable table 18. The deposited raw material may rotate with the grinding platform 20 of the rotatable table 18, and may pass under the rotating journal 52 to be ground, crushed, milled and/or pulverized. Simultaneous to the grinding process performed by the journal 52, high-temperature gas (e.g., air) may be provided to the separator body 12 via the gas inlet 26. The high-temperature gas may flow from the opening of the gas inlet 26 to the coal on the grinding platform 20 via the vane wheel assembly 24 to flash-dry the coal rotating on the grinding platform 20.

Coal that is not adequately and/or capable of being ground (e.g., coal that is too big, too hard, impure) may be rejected, discharged and/or discarded from the grinding platform 20 of the rotatable table 18 and may fall through the vane wheel assembly 24 to a collection area underneath the vane wheel assembly 24. In one embodiment, the vane wheel assembly 24 can include passages or openings formed about the circumference of the vane wheel assembly and the grinding platform 20 of the rotatable table 18. To this extent, centrifugal forces due to the rotation of the vane wheel assembly 24, the grinding platform 20, and the rotatable table 18 will direct the undesired coal radially outward toward the circumferentially located passages for rejection, discharge, discard and/or removal to the collection area. Once the rejected, discharged, discarded and/or removed coal is positioned within the collection area, a scraper (not referenced in FIG. 1) coupled to the rotatable table 18 may push and/or move the coal to a chute (not shown) to remove the material from the collection area and prevent build-up material.

Coal that is not rejected, discharged, discarded and/or removed may remain on the grinding platform 20 of the rotatable table 18 and may be ground and dried as discussed herein. Once the coal reaches a desired particle size (e.g., a size that satisfies a fineness size threshold), it may move (e.g., float, blown) upwards from the grinding platform 20 in a direction towards the separator top cover 16. In a non-limiting example, a suction may be applied within the separator body 12 to move and/or draw the coal particles towards the separator top cover 16. In particular, these coal particles may move towards the classifier 32 for particle screening. Coal particles that travel beyond the reach of the classifier 32 can move toward the interior surface 38 of the top surface 40 of the separator top cover 16. Coal particles that contact the interior surface 38 of the top surface 40 of the separator top cover 16 can either fall back toward the grinding platform 20, or may move toward the classifier 32. In this manner, the interior surface 38 of the top surface 40 of the separator top cover 16 can prevent particles of coal from exiting the separator top cover 16 of the separator body 12 without passing through the classifier 32.

The raw material particles that may reach the classifier 32 may undergo a screen process to determine if the coal particles meet a characteristic threshold(s) (e.g., size, fineness versus coarseness) by passing through the classifier. If the particles do not meet the characteristic threshold, the coal particles may be forced down to the grinding platform 20 via the reject cone 30 to undergo further grinding and/or drying. If the particles meet the characteristic threshold, a swirling flow of coal particles are directed up the reject cone 30 to the annular body 36 and the spaced static vanes 42 of the annular body. The static vanes 42 can divide the swirling flow of particles entering the annular body 36 into a plurality of swirling flows of particles circulating about the sections 46 of the annular body 36. The deflector ring 48 receives the plurality of swirling flows of particles circulating about the annular body 18 and directs these swirling flows towards the outlet housing 50. The outlet housing 50 can receive these swirling flows, and guide the swirling flows into a plurality of controlled flows that are communicated to the one or more outlet channels 34 for discharge and use as fuel with a coal-fired boiler that can operate within a coal-based power generation system. As discussed below in more detail, the shape (e.g., frusto-conical shape) of the outlet housing 50 may aid in distributing the particles of coal into the one or more particle outlet channels 34. Additionally, the deflector ring 48 may aid in distributing the particles of coal into the one or more particle outlet channels 34 and/or may prevent coal from becoming trapped and/or clogging the separator top cover 16 of the separator body 12.

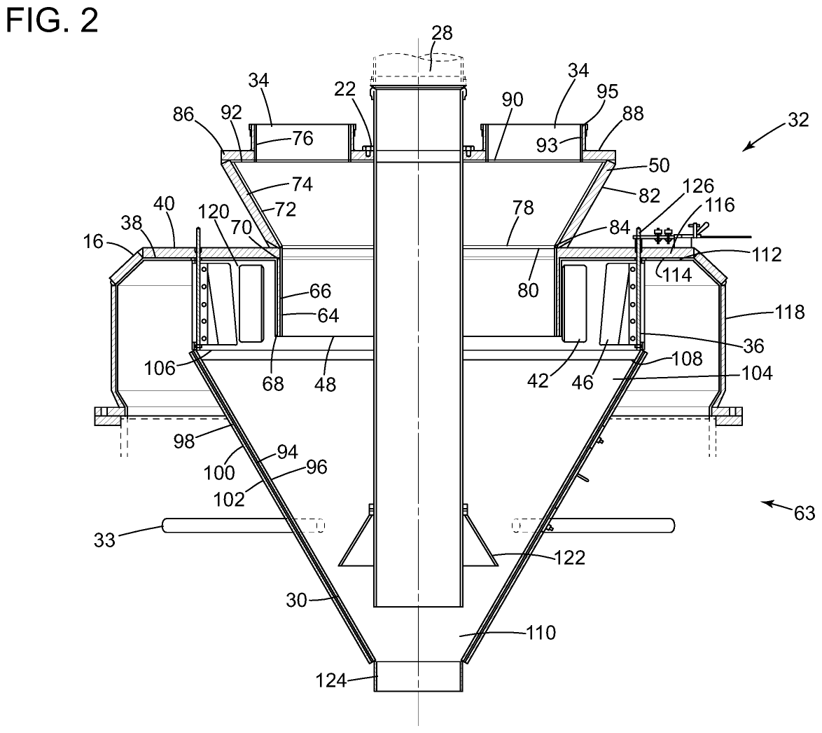

FIG. 2 depicts a more detailed view of the classifier 32 including the reject cone 30, the annular body 36, the deflector ring 48, and the outlet housing 50 in relation to the separator body 12 and the separator top cover 16 depicted in FIG. 1 according to an embodiment of the present invention. For purposes of describing the various embodiments and the benefits imparted to the pulverizer 10, the classifier 32 including the reject cone 30, the annular body 36, the deflector ring 48, and the outlet housing 50 in relation to the separator body 12 and the separator top cover 16 can be referred to as a classification zone 63 of the pulverizer 10. As shown in FIG. 2, the deflector ring 48 can comprise an interior sidewall liner 64 circumferentially affixed to an interior sidewall 66 of the deflector ring 48 and an exterior sidewall liner 68 circumferentially affixed to an exterior sidewall 70 of the deflector ring 48. Both the interior sidewall liner 64 and the exterior sidewall liner 68 can operate to protect the interior sidewall 66 and the exterior sidewall liner 68, respectively, from the wear that would otherwise be incurred from these sidewalls being struck by particles of coal that are entrained in the flow of air, as the flow of air flows upwardly from the reject cone 30 towards the annular body 36 and the deflector ring 48. This can be advantageous with coal that has a high ash content where Silica and Pyrite inclusion is high. To this extent, the use of the liners improves the wear life of the interior sidewall 66 and the exterior sidewall 70 of the deflector ring 48 from the ill effects of high ash coal content.

The interior sidewall liner 64 and the exterior sidewall liner 68 can take the form of any of a number of possible implementations. For example, the interior sidewall liner 64 and the exterior sidewall liner 68 can include plates that are affixed to the interior sidewall 66 and the exterior sidewall liner 68, respectively. In one embodiment the interior sidewall liner 64 and the exterior sidewall liner 68 can include a ceramic liner. It is understood that the interior sidewall liner 64 and the exterior sidewall liner 68 can include or other types of suitable abrasion resistant materials including, but not limited to, wear resistant plates, Hi-Chrome alloy castings, and/or the like.

As shown in FIG. 2, the classifier 32 can utilize liners of similar implementation and material at other locations to protect surfaces from the wear that would result due to being struck by particles of coal that are entrained in the flow of air, thereby increasing the wear life of these components of the classifier. For example, the outlet housing 50 can include an interior sidewall liner 72 affixed to the interior sidewalls 74 and an upper wall liner 76 located about the one or more particle outlet channels 34. In one embodiment, as shown in FIG. 2, the outlet housing 50 can comprise a base region 78 formed on a top surface 80 of the deflector ring 48, peripheral outlet housing sidewalls 82 (referred as opposing angled sidewalls in following descriptions for ease of understanding with respect to the given figures), each extending outward at an angle away from an edge 84 of the top surface of the deflector ring, and a top region 86 parallel to the base region 78 that joins with each of the opposing angled sidewalls 82 extending outward from the edge 84 of the top surface 80 of the deflector ring 48. As shown in FIG. 2, the top region 86 can have an upper surface 88 extending thereover with one or more openings 90 formed therein corresponding to the one or more outlet channels 34.

In one embodiment. the interior sidewall liner 72 of the outlet housing 50 can be affixed to an interior surface 74 of each of the angled sidewalls. Each interior sidewall liner 72 can extend from a corresponding edge 84 of the top surface 80 of the deflector ring 48 to a respective portion of the top region 86. The upper wall liner 76 of the outlet housing 50 can be affixed to an inner wall 92 of the upper surface 88 of the top region 86. To this extent, the upper wall liner 76 can extend along all of the inner wall 92 of the upper surface 88 of the top region 86 formed between the one or more openings 90. In one embodiment, the upper wall liner 76 affixed to the inner wall 92 of the upper surface 88 of the top region 86 of the outlet housing 50 can comprise an outlet channel extension liner 93 that extends upward along inner walls 95 of the one or more outlet channels 34. With this use of the liners about the various surfaces of the outlet housing, the ill effects that high ash coal can have on the wear life of the outlet housing can be obviated. That is, the liners on the inner surfaces of the outlet housing can extend the wear life of the outlet housing.

In another embodiment, the reject cone 30 is another element of the classifier 32 that can utilize liners of similar implementation and material as described above to protect surfaces from the wear that would result from being struck by particles of coal. For example, the reject cone 30 can include an interior sidewall liner 94 affixed to each interior surface 96 of the sidewalls 98 of the reject cone and an exterior sidewall liner 100 affixed to each exterior surface 102 of the sidewalls of the reject cone. In one embodiment, as shown in FIG. 2, the reject cone 30 can comprise an upper region 104 co-planar with a bottom side 106 of the annular body 36 and the reject cone opposing sidewalls 98 that each extend inward at an angle away from an edge 108 of the bottom side 106 of the annular body 36. In addition, the reject cone 30 can comprise a lower region 110 parallel to the upper region 104. To this extent, the reject cone 30 can receive coarse particles (e.g., undesired particles of size, shape, texture, etc.) falling out from the plurality of swirling flows of particles in the upper region 104 and direct the falling coarse particles in a direction away from annular body 36, the deflector ring 48 and the outlet housing 50 towards the lower region 110 of the reject cone 30 for removal therefrom. In this configuration, the interior sidewall liners 94 and the exterior sidewall liners 100 can extend from the upper region 104 to the lower region 110 of the reject cone 30. To this extent, the liners will protect the inner and outer surfaces of the reject cone 30 from the ill effects that high ash coal can have on the wear life of the outlet housing due to the inclusion Silica and Pyrites. As a result, the inner and outer surfaces of the reject cone 30 can have an improved or extended wear life.

It is understood that the classifier 32 is not the only region of the pulverizer 10 that is suitable to utilize the aforementioned liners to protect surfaces from the wear that can result from being struck by particles of coal. For example, an abrasion resistant liner 112 can be affixed to an interior surface 114 of a top surface 116 of the substantially closed separator body 12 about the top cover 16 and a portion of sidewalls 118 extending downward from the top cover 16 towards the top portion of the separator body.

In one embodiment, the abrasion resistant liner 112 can be affixed to the interior surface 114 of the top surface 116 of the separator body 12 about the top cover 16, extending along the entire inner wall of the top surface 116 from the edge 84 of the top surface 80 of the deflector ring 48 covering over a portion of an upper region 120 of the annular body 36, extending outward beyond a periphery of the annular body 36 and the reject cone, and downward beyond the annular body, facing an upper portion of the inward angled sidewalls 98 of the reject cone 30. It is understood that the liner thickness, material use for the liner and application area of the liner is variable, and may change for different types of coal mill geometries.

Those skilled in the art will appreciate that the liner thickness, material, and application area will be guided by desired coal-air mixture velocities at different zones of the classifier 32. Like the use of the other aforementioned liners, these liners will protect the inner surfaces about the top cover 16 and the upper portion of the separator body 12 from the ill effects that high ash coal can have on the wear life of these components due to the inclusion Silica and Pyrites. As a result, these inner surfaces about the top cover 16 and the upper portion of the separator body 12 can have an improved or extended wear life.

Overall the use of the liners about the various surfaces of the deflector ring 48, the outlet housing 50, the reject cone 30, the separator top cover 16 and the separator body 12 will protect these components from high ash coal content which will extend their respective wear lives. As a result of these wear life improvements, the classifier segment will have considerably improved availability and reliability.

FIG. 2 further illustrates other features of the classifier 32 that enable the pulverizer 10 of FIG. 1 to better manage the coal and the air in a way that improves efficiency in the crushing, milling and pulverizing operations, and consequently, allows the pulverizer 10 to run with higher coal throughput with desired fineness, and thus, restoring milling capacity. For example, in one embodiment, the separator top cover 16 that is used to cover the substantially-closed separator body 12 of the pulverizer 10 can have its dimensions modified in order to provide more space for retention time of coal particles. In one embodiment, the vertical height and diameter of the separator top cover 16 can be increased to provide more space for retention time of the coal particles. Another dimensional modification to the separator top cover 16 can include decreasing the opening of the cover that couples to the outlet housing that is used to discharge the pulverized particles from the pulverize 10. To this extent, a decreased opening at the separator top cover 16 can result in coal-air outlet velocity optimization at the outlet housing 50, which provides a uniform distribution of the coal-air mixture thru the particle outlet channels 34 of the outlet housing 50.

The outlet housing 50 is another component about the classifier that can be modified in order to improve classification. For example, the outlet housing 50 can have a truncated cone-shaped body such as a frusto-conical shaped body as described above. The frusto-conical shaped body of the outlet housing 50 placed on top of the classifier 32 ensures a proper coal-air flow distribution through the particle outlet channels 34 with minimized wear rate. As a result, uniform distribution of coal flow through the particle outlet channels 34 maintains the similar flow rate through each outlet channel with even coal fineness and desired pressure balancing.

The material inlet channel 22 can be configured to have features which can contribute to the pulverizer 10 having the ability to run with higher coal throughput with desired fineness, and better efficiency. For example, in one embodiment, as shown in FIG. 2, the material inlet channel 22 can have an inverted cone 122 located at a lower portion of the material inlet channel. The inverted cone 122 at the lower portion of the material inlet channel 22 is beneficial in that the adjustable annular gap formed by the inverted cone 122 in the reject cone 30 maintains the required flow passage of returned coarse particle from the classifier 32. In one embodiment, the gap between the inverted cone 122 and the reject cone 30 can be maintained uniform and within the range of about 65 to about 90 millimeters.

The reject cone 30 is another component of the pulverizer 10 that can be configured to have features which can contribute to the pulverizer 10 having improved throughput and efficiency. For example, in one embodiment, as shown in FIG. 2, the reject cone 30 can have a spout 124 coupled to the lower region 110 of the reject cone. The spout 124 at the lower region 110 of the reject cone 30 is beneficial in that the fine particles can exit the mill thru the fuel pipes (i.e., the particle outlet channels 34) and the coarse particles can return to the rotatable table 18 and the grinding platform 20 thru the reject cone 30 for further size reduction.

In one embodiment, the gap between the reject cone 30 and material inlet channel 22 can be maintained uniform and within the range of about 100 to about 125 millimeters. In this manner, the spout coupled at the bottom of the reject cone 30 can channelize coal inlet flow direction to the rotatable table 18 reducing the impact load.

It is understood that the various shapes, geometries and/or configuration of the various components of the classifier 32 as depicted in FIGS. 1 and 2 can be changed and still be a part of the claimed invention. This is even if any changes will provide a higher efficiency and/or a better management of coal and/or air in the pulverizer 10.

For example, the annular body 36 can have its diameter and height changed to improve efficiency of the pulverizer 10. In one embodiment, the diameter and height of the annular body 36 can be reduced in size. Additionally, the window openings formed between the plurality of sections 46 can be reduced by increasing the number of the plurality of spaced static vanes 42.

For example, the number of the plurality of spaced static vanes 42 can be increased from 28 to 36. In one embodiment, the profile and size of the static vanes 42 can be modified to aid in increasing the efficiency, throughput, and management of the coal and air in the pulverizer 10.

For example, the number of the static vanes 42 can be increased (e.g., increased from 28 to 36) and/or the profile of the vanes can be redesigned to allow adjustable fineness results.

In one embodiment, the static vanes 42 can be increased and/or the profile of the vanes can be redesigned to allow adjustable fineness results through access to each of the plurality of spaced static vanes 42 via the regulator link assembly 126. In addition to the annular body 36, the dimensions of the reject cone 30 and the deflector ring 48 can be optimized to aid in increasing the efficiency, throughput, and management of the coal and air in the pulverizer 10.

### Example 2

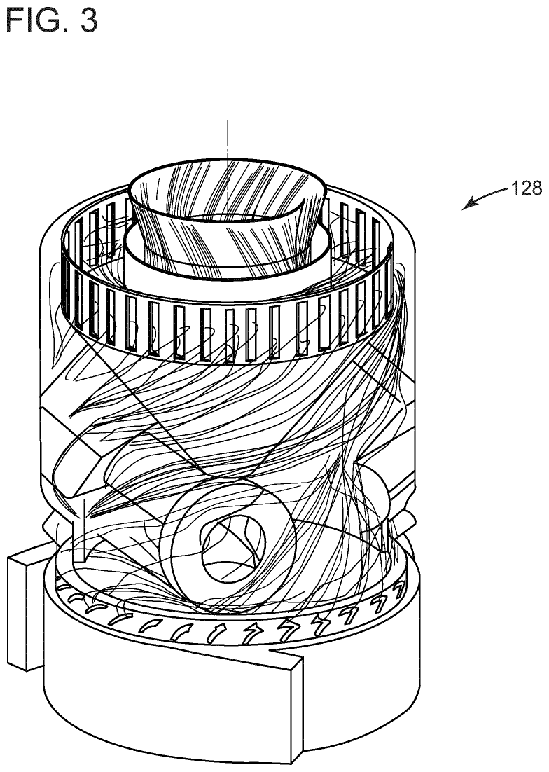

FIG. 3 depicts a schematic representation 128 of the distribution and movement of particles of coal in the pulverizer 10 that can be attained with any of the various embodiments described herein.

As shown in FIG. 3, the representation 128 makes apparent that the distribution of the coal particles is uniform, which generally is due to uniform flow velocities of the particles in the pulverizer 10 such as in the classification zone 63 and the other classification zone of the pulverizer that occurs about the rotatable table 18, the grinding platform 20, the vane wheel assembly 24.

In one embodiment, the classification zone 63 in the pulverizer 10 can be referred to as a secondary or static classifier, while the classification zone that occurs about the rotatable table 18, the grinding platform 20, the vane wheel assembly 24 can be referred to as the primary classifier.

This uniform distribution of particles of coal that is afforded by the static classifier and the primary classifier provides an optimum flow path for the coal so that there is maximum retention of the particles in the pulverizer 10.

As a result, the pulverizer 10 is able to increase pulverizer classification with substantially reduced localized wear of the various components of the pulverizer. Consequently, the pulverizer 10 has better fineness control at no extra pressure drop (because of better dynamic management of air and fuel), which causes the undesired coal particles (e.g., heavier, larger, particles) to be directed to the rotatable table 18, the grinding platform 20, the vane wheel assembly 24 for further pulverization. For example, the pulverizer 10 can attain a fineness control of mesh particles that is less than one percent through (+)50 mesh or better.

### Example 3

A classifier and a pulverizer according to the invention were further tested in comparison to known prior art classifiers and pulverizers.

Operating data are presented in a table below and a brief description of the procedure of the test follows.

| | | Pre- | Post-modification | | |
|---|---|---|---|---|---|
| | | modification | (sample) | | Acceptable |
| Parameters | | (sample) | Trial Run - 1 | Trial Run - 2 | Range |
| Operating Data | Units | Value | Value | Value | Value |
| Per Mill Coal | kg/hr | 28300 | 32000 | 32400 | >31500 |
| Flow | | | | | |
| Per Mill primary | kg/hr | 53000 | 52000 | 53000 | 45000-65000 |
| Air Flow | | | | | |
| PA Inlet | ° C. | 290 | 265 | 204 | 210-300 |
| Temperature | | | | | |
| Mill Outlet | ° C. | 72 | 82 | 75.4 | 65-85 |
| Temperature | | | | | |
| Mill Inlet or H.A. | KPa | 605 | 633 | 674.5 | 500-750 |
| Duct Pressure | | | | | |
| Coal Fineness | | | | | |
| % Thru 200 Mesh | | 75-80% | 77.50% | 78.00% | >75% |
| % on 50 Mesh | | <1% | <1% | <1% | <1% |
| Motor Current | Amps | 37 | 36.7 | 38.1 | 34-39 |
| Bowl DP | KPa | 170-180 | 234 | 264 | 180-270 |

The coal feed rate set as required for the “test load condition”.

Data and sample collection begun after stable (steady state) mill operation has been obtained. A mill is in a steady state condition if the bowl differential pressure, mill power (motor current), and mill outlet temperature are all in equilibrium:
1) The bowl differential pressure is in equilibrium if two 30 seconds averages taken 30 minutes apart differ by less than 1%.
2) The pulverizer power is in equilibrium if two 30 seconds averages (watt meter or motor current) taken 30 minutes apart differ by less than 1%.
3) The mill outlet temperature is in equilibrium if two instantaneous temperature measurements taken 30 minutes apart differ by less than 3 degrees.

Pulverizer Operating Data recorded by the DCS at the beginning of the test and at 1-minute intervals thereafter. Raw coal samples collected at feeder inlet at 30 minutes interval. Sample tested for Moisture, HGI, Ultimate/proximate analysis. The pulverized coal samples collected at beginning and mid-point of the test. Fineness testing done at site lab and found as meeting the desired values.

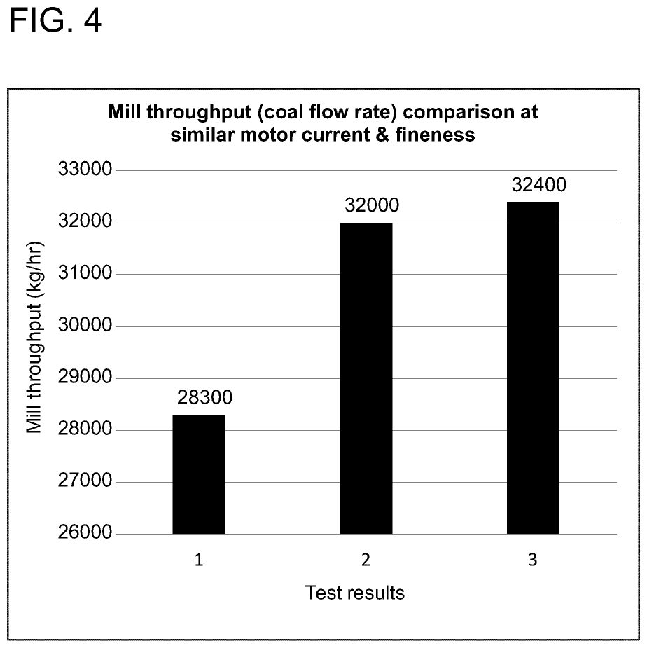

FIG. 4 depicts a comparison of the mill throughput (coal flow rate) between a pulverizer having a classifier according to embodiments of the invention versus a pulverizer with a classifier without the features of the embodiments, at similar motor current and fineness for a pulverizer.

### Example 4

In this example, the wear improvement was tested. Tests involved a classifier and a pulverizer with lining and/or abrasive resistant lining and without lining (reference).

The trial runs revealed that parts covered with liner have reduced wear. Measurements were done using standardized methods based on abrasive index. It is clear that the time between servicing of these elements increased by 25%-75%. Longer wear life were obtained when ceramic liner was used.

The wear life depends on characteristic of coal used in the test and it was noted that wear life was reduced for coals with high ash and silica contents. In trials where exact same coal was used for a classifier and a pulverizer with lining and without lining, lining increased wear life by 60%. Longer wear life was obtained when ceramic liner was used.

It is further to be understood that the above description is intended to be illustrative, and not restrictive. For example, the above-described embodiments (and/or aspects thereof) may be used in combination with each other. Specifically, combinations of any or all of examples/embodiments disclosed herein is within the scope of this disclosure. Additionally, many modifications may be made to adapt a particular situation or material to the teachings of the invention without departing from its scope. For example, in one embodiment, a method of controlling an output of coal discharged from a coal pulverizer is provided based on the implementation of the aforementioned components. While this method is suitable for use on newly manufactured pulverizers, this method can be directed to modifying or retrofitting existing pulverizers with the features and capabilities described herein. To this extent, this method enables these existing pulverizers to restore capacity while attaining all of the benefits and features describe herein.

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means- plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, the terms “substantially,” “generally,” and “about” indicate conditions within reasonably achievable manufacturing and assembly tolerances, relative to ideal desired conditions suitable for achieving the functional purpose of a component or assembly. Furthermore, an element or step recited in the singular and proceeded with the word “a” or “an” should be understood as not excluding plural of said elements or steps, unless such exclusion is explicitly stated. In addition, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

1. A classifier comprising an annular body having:
a plurality of spaced static vanes extending inwardly from an interior sidewall of the annular body, the plurality of spaced static vanes separating the annular body into a plurality of sections, wherein the plurality of spaced static vanes are configured to divide a swirling flow of particles entering the annular body into a plurality of swirling flows of particles circulating about the plurality of sections of the annular body,
a deflector ring located interior to the annular body, circumferentially facing the inwardly extending plurality of spaced static vanes, wherein the deflector ring is configured to receive the plurality of swirling flows of particles circulating about the annular body,
an outlet housing having one or more outlet channels mounted over the deflector ring, wherein the outlet housing is in fluid communication with the deflector ring, wherein the outlet housing is configured to receive fine particles in the plurality of swirling flows of particles that are directed upward from the deflector ring and guide the fine particles in the plurality of swirling flows into a plurality of controlled flows that are communicated to the one or more outlet channels for discharge, and
a reject cone extending downward from a bottom side of the annular body, wherein the reject cone having an upper region co-planar with the bottom side of the annular body and reject cone opposing sidewalls, each extending inward at an angle away from an edge of the bottom side of the annular body, and a lower region parallel to the upper region, wherein the reject cone is configured to receive coarse particles falling out from the plurality of swirling flows of particles in the upper region and direct the falling
coarse particles in a direction away from annular body, the deflector ring and the outlet housing towards the lower region of the reject cone for removal therefrom, wherein
the deflector ring comprises an interior sidewall liner circumferentially affixed to an interior sidewall of the deflector ring and an exterior sidewall liner circumferentially affixed to an exterior sidewall of the deflector ring,
the outlet housing comprises a frusto-conical shaped body, a base region formed on a top surface of the deflector ring, outlet housing opposing sidewalls, each extending outward at an angle away from an edge of the top surface of the deflector ring, and a top region parallel to the base region that joins with each of the opposing angled sidewalls extending outward from the edge of the top surface of the deflector ring, the top region having an upper surface extending thereover with one or more openings formed therein corresponding to the one or more outlet channels,
wherein the outlet housing further comprises an interior sidewall liner affixed to an interior surface of each of the opposing angled sidewalls, each interior sidewall liner extending from a corresponding edge of the top surface of the deflector ring to a respective portion of the top region, and an upper wall liner affixed to an inner wall of the upper surface of the top region, the upper wall liner extending along all of the inner wall of the upper surface of the top region formed between the one or more openings.

2. The classifier according to claim 1, wherein the reject cone comprises an interior sidewall liner affixed to each interior surface of the sidewalls of the reject cone and an exterior sidewall liner affixed to each exterior surface of the sidewalls of the reject cone.

3. The classifier according to claim 2, wherein the interior sidewall liners and the exterior sidewall liners extend from the upper region to the lower region of the reject cone.

4. The classifier according to claim 1, wherein the upper wall liner affixed to the inner wall of the upper surface of the top region of the outlet housing comprises an outlet channel extension liner that extends upward along inner walls of the one or more outlet channels.

5. The classifier according to claim 1, wherein the interior sidewall liner, the exterior sidewall liner, upper wall liner and/or outlet channel extension liner comprises a ceramic liner material, wear resistant plates and/or Hi-Chrome alloy castings.

6. The classifier according to claim 1, wherein a spout is coupled to the lower region of the reject cone.

7. A pulverizer comprising:
a substantially closed separator body configured to receive particles of material,
a rotatable table located in the interior of the substantially closed separator body configured to receive the particles of material, at least one grinding roll configured to grind the particles of material against the rotatable table,
a gas inlet to the substantially closed separator body, wherein the gas inlet is configured to direct an upward flow of gas from circumferential regions of the rotatable table, wherein the upward flow of gas directs pulverized particles of material received at the circumferential regions of the rotatable table due to centrifugal forces of the rotatable table in an upward direction, wherein the pulverized particles are entrained in the upward flow of gas,
a classifier supported in the substantially closed separator body above the rotatable table to receive the upward flow of pulverized particles from the rotatable table, wherein the classifier is configured to sort the particles entrained in the upward flow into particles of a desired size and particles of an undesired size,
wherein the classifier directs the particles of the desired size out from a top surface of the substantially closed separator body and directs the particles of the undesired size back towards the rotatable table for additional grinding with the at least one grinding roll,
wherein the classifier is as claimed in claim 1.

8. The pulverizer according to claim 7, wherein an abrasion resistant liner is affixed to an interior surface of the top surface of the substantially closed separator body and a portion of sidewalls extending downward from the top surface of the substantially closed separator body.

9. The pulverizer according to claim 8, wherein the abrasion resistant liner affixed to the interior surface of the top surface of the substantially closed separator body joins with the exterior sidewall liner circumferentially affixed to the exterior sidewall of the deflector ring.

10. The pulverizer according to claim 8, wherein the abrasion resistant liner affixed to the interior surface of the top surface of the substantially closed separator body extends along the entire inner wall of the top surface from an edge of the top surface of the deflector ring covering over a portion of an upper region of the annular body, extending outward beyond a periphery of the annular body and the reject cone, and downward beyond the annular body, facing an upper portion of the inward angled sidewalls of the reject cone.

11. The pulverizer according to claim 7, wherein an inlet channel extends through the substantially closed separator body into the classifier to supply the particles of material to the rotatable table, wherein the inlet channel comprises an inverted cone at a lower portion of the inlet channel.

12. The pulverizer according to claim 8, wherein the abrasion resistant liner comprises a ceramic liner material, wear resistant plates and/ or Hi-Chrome alloy castings.

13. A method of operation of a pulverizer as defined in claim 7, wherein said method comprises providing feed of coal to the pulverizer and obtaining pulverized coal from the pulverizer.

14. A use of the classifier as claimed in claim 1 for separating particles of coal in a pulverizer.
